(19) United States
(12) Patent Application Publication
(10) Pub. No.: US 2012/0308957 A1
(43) Pub. Date: Dec. 6, 2012

(54) DENTAL ROOT CANAL TREATMENT INSTRUMENT AND MANUFACTURING METHOD THEREOF

(75) Inventor: Kazuaki Katoh, Utsunomiya-shi (JP)

(73) Assignee: MANI, INC., Utsunomiya-shi, Tochigi (JP)

(21) Appl. No.: 13/578,624

(22) PCT Filed: Feb. 25, 2011
(86) PCT No.: PCT/JP2011/054259

§ 371 Date: Aug. 12, 2012

(30) Foreign Application Priority Data
Feb. 26, 2010 (JP) 2010-041907

(51) Int. Cl. A61C 5/02; B29C 37/02; B29C 45/14

(52) U.S. Cl. 433/102; 264/274; 264/138

(57) ABSTRACT

Manufacturing a working portion and a joined portion through the same processing method provides a dental root canal treatment instrument allowing a simplified manufacturing process. A metal, rod-like main frame 11 includes a working portion 11a having a tapered point to be inserted in a root canal during use, and a joined portion 11b buried within a handle 12, continuing to the end on the wide side of the working portion. The working portion and the joined portion are formed through the same processing method. Injection of a synthetic resin to cover the joined portion 11b prepares the handle 12, thereby forming a dental root canal treatment instrument 10. The joined portion has at least one concave portion or convex portion in order to reinforce the joint with the handle.

### TECHNICAL FIELD

The present invention relates to a dental root canal treatment instrument and a manufacturing method thereof used when grinding down a root canal inner wall and filling it with a filler in dental root canal treatment.

### BACKGROUND ART

Dental root canal treatment treats dental roots by removing dentin and nerves infected by bacteria using a dental root canal treatment instrument such as a reamer or a file.

FIG. 4 is a perspective view of a conventional handheld dental root canal treatment instrument (reamer). A reamer 20 has a main metal frame 21 and a synthetic-resin handle 22, where a working portion 21a on the front edge of the main frame 21 is a cutting tool. A practitioner grabs the handle 22 and inserts the tip of the working portion 21a into a root canal, rotates it, and pushes and pulls so as to cut the inner wall and enlarge the root canal. In this case, as the dental root canal treatment instrument such as the reamer 20 is rotated at times during use, a joined portion of the main frame 21 and the handle 22 shall not be loose nor shall it spin during rotation.

FIG. 5 is a cross-sectional view of the joined portion of a conventional handheld dental root canal treatment instrument. The conventional handheld dental root canal treatment instruments disclosed in Patent Document 1 (JP H05-146455 A) and Patent Document 2 (JP H09-154853 A) are provided with a folded portion 21b, which is formed by bending the base, and a widened portion 21c, which is formed by squashing a part of the base using a press, at a portion buried in the handle 22 of the main frame 21. The handle 22 is injection molded, covering the formed folded portion 21b and the widened portion 21c, and is thereby integrated securely against rotation and pulling out. Note that typically, either the folded portion 21b or the widened portion 21c is formed in many cases, where the folded portion 21b is formed when the diameter of the main frame 21 is small, and the widened portion 21c is formed when it is large.

In this case, formation of the folded portion 21b and the widened portion 21c as disclosed in Patent Document 1 and Patent Document 2 needs to be carried out through a different process than formation of the working portion 21a due to the shape thereof In other words, manufacturing of the main frame 21 of the reamer 20 or the like is carried out through a different processing method from the process forming the working portion 21a and process forming the folded portion 21b and the widened portion 21c using a different device.

As operations are carried out using different devices and different processing methods, it is necessary to remove an instrument from a device and transport it to another location in the intervals of respective operations, thereby increasing processes and time required, leading to increase in production cost.

Meanwhile, there are dental root canal treatment instruments called a spreader and a plugger, which are tools constituted by a metal, rod-like main frame and a synthetic resin handle in the same manner as the reamer and the file. The spreader or the plugger may be used for compaction of a root canal filler called gutta-percha, so as to keep bacteria and the like from entering the root canal after a nerve is removed using a reamer or the like. The spreader may be inserted close to the apex of the root since the tip of the working portion is sharp, and is thus appropriate for lateral compaction of gutta-percha while the plugger is appropriate for vertical compaction of gutta-percha since it has a flat working portion tip. Since a dental root canal treatment instrument, such as the spreader or the plugger, is hardly ever rotated during use as is the reamer, for example, the joined portion of the main frame and the handle does not need to be strengthened against rotation as long as it does not become loose or unfasten when pushed and pulled or moved to the side.

### PRIOR ART DOCUMENTS

### Patent Documents

Patent Document 1: JP H05-146455 A

Patent Document 2: JP H09-154853 A

### DISCLOSURE OF INVENTION

### Problem to be Solved by the Invention

In light of these conditions, the present invention aims to provide a dental root canal treatment instrument and a manufacturing method thereof that can manufacture a metal, rod-like main frame easily by forming a joined portion and a working portion using a common device through the same processing method, wherein the dental root canal treatment instrument has sufficient strength against rotation and pulling out according to use.

### Means of Solving the Problem

The dental root canal treatment instrument according to the present invention is provided with a synthetic resin handle on a metal, rod-like main frame. It is characterized by the main frame including a working portion having a tapered point to be inserted in a root canal during use, and a joined portion buried within the handle, continuing to the end on the wide side of the working portion. The working portion and the joined portion are formed through the same processing method.

The joined portion should have at least one concave portion or convex portion. Moreover, the joined portion may also include a plurality of crossing spiral grooves or a plurality of twisted portions running along opposite axes, and the working portion and the joined portion of the main frame may be formed integrally around the same central axis. Furthermore, the concave portion and/or the convex portion may be a constricted portion and/or an expanded portion.

A manufacturing method for a dental root canal treatment instrument according to the present invention provided with a synthetic resin handle on a metal, rod-like main frame, and is characterized by including the steps of: forming through the same processing method, a working portion having a tapered point to be inserted in a root canal during use, and a joined portion buried within the handle, continuing to the end on the wide side of the working portion in the main frame; and injecting a synthetic resin to cover the joined portion so as to prepare the handle.

The step of forming the working portion and the joined portion through the same processing method may be carried out by any one of cutting, grinding, or a spiral-twisting method. Alternatively, operations of forming the working portion and the joined portion through the same processing method may be carried out continuously. In this case, either the working portion or the joined portion may be formed first.

### Result of the Invention

The dental root canal treatment instrument and the manufacturing method thereof according to the present invention allows sufficient reinforcement of the joint at the handle and processing of the joined portion with the working portion of the main frame using the same method, thereby allowing a simple manufacturing process and reduced production cost.

### BRIEF DESCRIPTION OF DRAWINGS

FIG. 1 illustrates a dental root canal treatment instrument according to the present invention, where 1(a) is a top view and 1(b) is a cross-sectional view;

FIG. 2 is a diagram illustrating status of use of a plugger;

FIG. 3 illustrates an embodiment of the dental root canal treatment instrument according to the present invention, where 3(a) is a top view of a working portion in which spiral cutting blades are formed and a joined portion in which spiral grooves are formed, and 3(b) is a top view where the working portion and the joined portion are twisted;

FIG. 4 is a perspective view of a conventional handheld dental root canal treatment instrument; and

FIG. 5 is a cross-sectional view of the conventional handheld dental root canal treatment instrument.

### BEST MODE FOR CARRYING OUT THE INVENTION

An embodiment of the present invention is described while referencing the attached drawings.

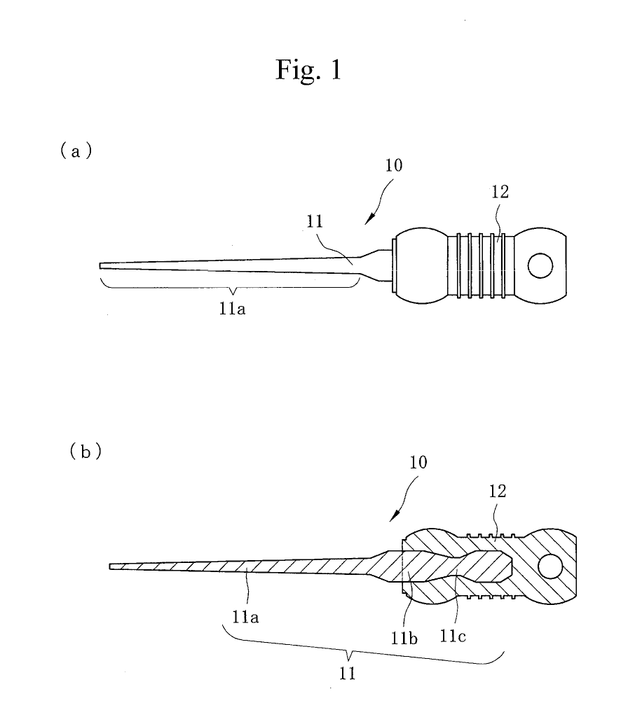

FIG. 1 illustrates a dental root canal treatment instrument according to the present invention, where 1(a) is a top view and 1(b) is a cross-sectional view. A dental root canal treatment instrument 10 is constituted by a metal, rod-like main frame 11 and a synthetic resin handle 12. The main frame 11 includes a working portion 11a and a joined portion 11b.

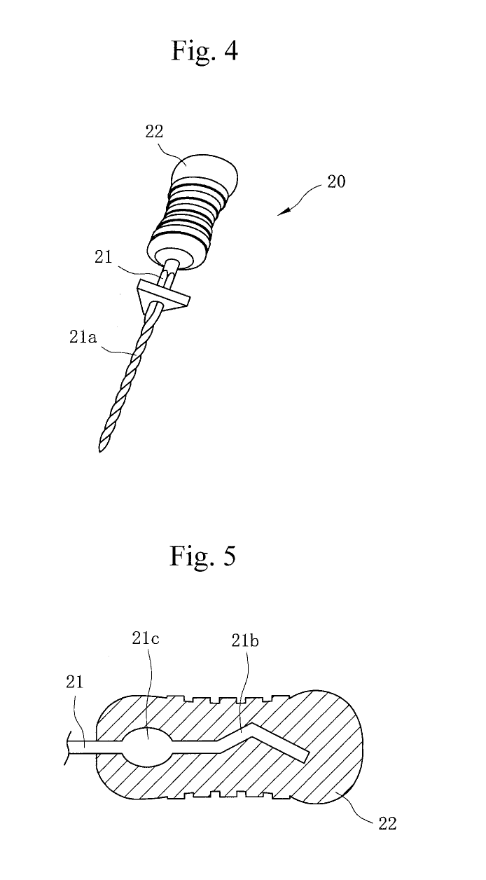

The working portion 11a has a tapered point to be inserted in a root canal when used. Accordingly, it has flexibility allowing deformation along the root canal. Note that the dental root canal treatment instrument 10 shown in FIG. 1 illustrates a plugger where the end of the working portion 11a is flat, however, in the case of a spreader, there is a difference in that the end thereof is pointed. However, according to the present invention, distinction between the spreader and the plugger is unnecessary, and either may be used. Moreover, in the case of the reamer or the file, the working portion has twisted cutting blades, such as 21a of FIG. 4, or spiral cutting blades.

The joined portion 11b is buried within the handle 12, continuing to the end on the wide side of the working portion 11a. The joined portion 11b has at least one concave portion or convex portion in order to reinforce the joint with the handle 12. Alternatively, the concave portion and/or the convex portion may be a constricted portion and/or a diameter expanded portion. Note that the cross-sectional view of FIG. 1(b) illustrates a diagram including a constricted portion 11c. On the other hand, this portion may be an expanded portion. This is because even the expanded portion has resistance against pulling out and the like. The expanded portion may be provided at the end of the joined portion 11b, or the constricted portion 11c or the expanded portion may be provided at multiple locations. Moreover, since the main frame 11 is formed on a single central axis when such a constricted portion 11c and/or expanded portion is provided, the working portion 11a and the joined portion 11b are formed around the same central axis. Furthermore, a D-cut shape may be formed in the concave portion and/or the convex portion, which thereby allows resistance in the rotative direction in addition to the pulling out direction.

In this case, concave and convex portions, such as the constricted portion 11c, the expanded portion, and the D-cut, may be formed through cutting work using a lathe. This allows integral manufacture of the working portion 11a up to the joined portion 11b, namely the entire main frame 11 through cutting work using a single device (a lathe), and thereby provides advantages of simplifying manufacturing and reducing production cost. Injecting a synthetic resin to cover the joined portion 11b formed in this manner and preparing the handle 12 completes the product form.

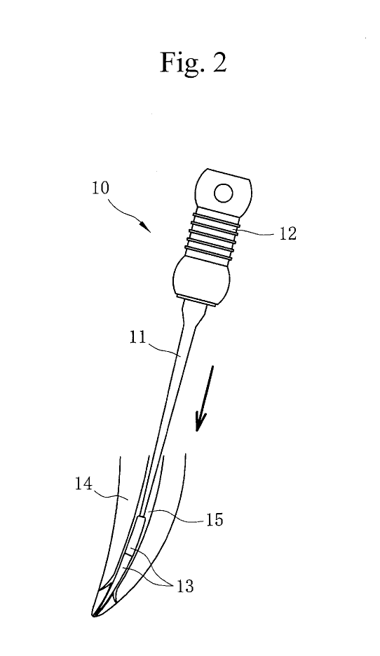

FIG. 2 is a diagram illustrating status of use of a plugger. A state where vertical compaction of gutta-percha 13 into a root canal 15 of a tooth 14 is carried out using a plugger as the dental root canal treatment instrument 10 is illustrated herein. When the practitioner grabs the handle 12 and moves the dental root canal treatment instrument 10 vertically so as to press the gutta-percha 13 along the root apex, the dental root canal treatment instrument 10 is essentially not rotated. That is, in the case where the concave portion and/or the convex portion is constricted portion 11c and/or expanded portion as shown in FIG. 1(b), the joint of the joined portion 11b and the handle 12 is not very strong against rotation, however, if it is not rotated during use as with the spreader or the plugger, there is no particular inconvenience.

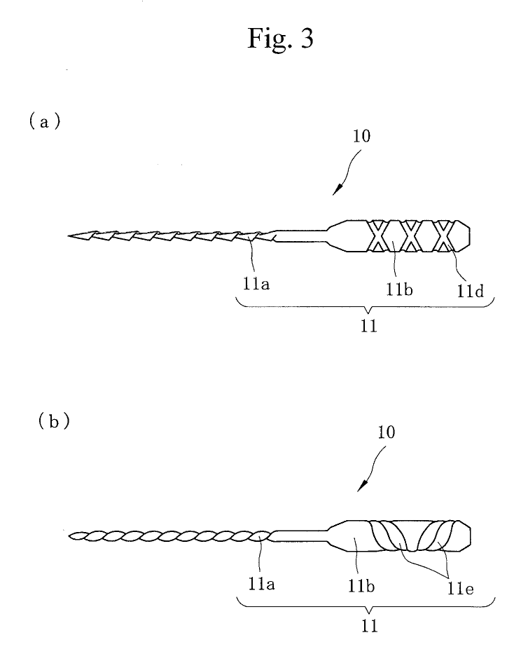

FIG. 3 illustrates an embodiment of the dental root canal treatment instrument according to the present invention, where 3(a) is a top view of the working portion 11a in which spiral cutting blades are formed and the joined portion 11b in which spiral grooves are formed, and 3(b) is a top view where the working portion 11a and the joined portion 11b are twisted. When the concave portion and/or the convex portion provided in the joined portion 11b is formed by multiple crossing spiral grooves 11d, as shown in FIG. 3(a), or when multiple twisted portions 11e running along opposite axes are formed, as shown in FIG. 3(b), it has strength against rotation and pulling out. Note that the spiral grooves 11d cross each other, and the twisted portions 11e run along opposite axes, thereby allowing resistance against rotation in the left and the right directions. Therefore, the joined portion 11b as in these embodiments allows application of not only the spreader and the plugger but the reamer and the file as well.

Here, in the case of providing the spiral cutting blades of the working portion 11a and the spiral grooves 11d of the joined portion 11b, as shown in FIG. 3(a), grinding should be performed using the device disclosed in Japan Examined Patent Publication No. SHO 61-50455. While this grinding is performed continuously using a common device, either the working portion 11a or the joined portion 11b may be formed first. As such, processing of the cutting blades of the working portion 11a and the spiral grooves 11d of the joined portion 11b is carried out through the same grinding method, allowing use of a single common device.

Moreover, in the case of providing spirally twisted cutting blades of the working portion 11a and the twisted portions 11e of the joined portion 11b, as shown in FIG. 3(b), spiral-twisting should be performed using the spiral-twisting device disclosed in JP 4168194. While this spiral-twisting is performed continuously using a common device, either the working portion 11a or the joined portion 11b may be formed first. As such, spiral-twisting of the cutting blades of the working portion 11a and the twisted grooves 11e of the joined portion 11b is carried out through the same spiral-twisting method, allowing use of a single common device.

In this manner, the dental root canal treatment instrument 10 and the manufacturing method thereof according to the present invention allows formation of the working portion 11a and the joined portion 11b through the same processing method using a single common device, thereby reinforcing the joint with the handle 12 and providing a simplified manufacturing process.

### DESCRIPTION OF REFERENCE NUMERALS

10: dental root canal treatment instrument
11, 21: main frame
11a, 21a: working portion
11b: joined portion
11c: constricted portion
11d: spiral groove
11e: twisted portion
12, 22: handle
21b: folded portion
21c: widened portion

1. A dental root canal treatment instrument provided with a synthetic resin handle on a metal, rod-like main frame;
the main frame comprising a working portion having a tapered point to be inserted in a root canal during use, and a joined portion buried within the handle, continuing to the end on the wide side of the working portion, and the working portion and the joined portion are formed through the same processing method.

2. The dental root canal treatment instrument of claim 1, wherein the joined portion comprises at least a concave portion and/or a convex portion.

3. The dental root canal treatment instrument of claim 1, wherein the joined portion comprises a plurality of crossing spiral grooves.

4. The dental root canal treatment instrument of claim 1, wherein the joined portion comprises a plurality of twisted portions running along opposite axes.

5. The dental root canal treatment instrument of claim 1, wherein the working portion and the joined portion provided to the main frame are formed integrally around the same central axis.

6. A manufacturing method for a dental root canal treatment instrument provided with a synthetic resin handle on a metal, rod-like main frame, comprising the steps of:
forming through the same processing method, a working portion having a tapered point to be inserted in a root canal during use, and a joined portion buried within the handle, continuing to the end on the wide side of the working portion in the main frame; and
injecting a synthetic resin to cover the joined portion so as to prepare the handle.

7. The manufacturing method for a dental root canal treatment instrument of claim 6, wherein the same processing method is either cutting, grinding, or a spiral-twisting method.
